(19) United States
(12) Patent Application Publication
(10) Pub. No.: US 2003/0025301 A1
(43) Pub. Date: Feb. 6, 2003

(54) Folding wagon assembly

(76) Inventor: Henry Banuelos III, Lakewood, CA (US)

Correspondence Address: Kaardal & Associates, PC, Attn: Ivar M. Kaardal, Suite 250, 3500 South First Ave. Circle, Sioux Falls, SD, 57105-5807, US

(21) Appl. No.: 09/732,556

(22) Filed: Dec. 8, 2000

(51) Int. Cl. B62B 3/00

(52) U.S. Cl. 280/651; 280/47.38

(57) ABSTRACT

A folding wagon assembly for enhanced portability and compact storage. The folding wagon assembly includes a wagon assembly comprising a folding bottom panel assembly and an upper rail assembly positioned in spaced relationship above the bottom panel assembly. Netting extends between the bottom panel assembly and the upper rail assembly to form a cargo compartment of the wagon. A pair of side members extend between the bottom panel assembly and the upper rail assembly. The upper rail assembly and the bottom panel assembly are each hingably coupled to the side members such that the upper rail assembly and the bottom panel assembly are foldable for compactly storing the wagon. A plurality of wheel assemblies are coupled to the bottom panel assembly for supporting the cargo compartment. A handle extends from the upper rail for facilitating movement of the cargo compartment.

### BACKGROUND OF THE INVENTION

1. Field of the Invention

The present invention relates to carts or wagons for transporting goods and more particularly pertains to a new folding wagon assembly for enhanced portability and compact storage.

2. Description of the Prior Art

The use of carts or wagons for transporting goods is known in the prior art. More specifically, carts or wagons for transporting goods heretofore devised and utilized are known to consist basically of familiar, expected and obvious structural configurations, notwithstanding the myriad of designs encompassed by the crowded prior art which have been developed for the fulfillment of countless objectives and requirements.

Known prior art includes U.S. Pat. No. 4,856,810; U.S. Pat. No. 2,563,995; U.S. Pat. No. 4,887,836; U.S. Pat. No. 4,811,968; U.S. Pat. No. 3,275,337; and U.S. Pat. No. Design 138,195.

While these devices fulfill their respective, particular objectives and requirements, the aforementioned patents do not disclose a new folding wagon assembly. The inventive device includes a wagon assembly comprising a folding bottom panel assembly and an upper rail assembly positioned in spaced relationship above the bottom panel assembly. Netting extends between the bottom panel assembly and the upper rail assembly to form a cargo compartment of the wagon. A pair of side members extend between the bottom panel assembly and the upper rail assembly. The upper rail assembly and the bottom panel assembly are each hingably coupled to the side members such that the upper rail assembly and the bottom panel assembly are foldable for compactly storing the wagon. A plurality of wheel assemblies are coupled to the bottom panel assembly for supporting the cargo compartment. A handle extends from the upper rail for facilitating movement of the cargo compartment.

In these respects, the folding wagon assembly according to the present invention substantially departs from the conventional concepts and designs of the prior art, and in so doing provides an apparatus primarily developed for the purpose of enhanced portability and compact storage.

### SUMMARY OF THE INVENTION

In view of the foregoing disadvantages inherent in the known types of carts or wagons for transporting goods now present in the prior art, the present invention provides a new folding wagon assembly construction wherein the same can be utilized for enhanced portability and compact storage.

The general purpose of the present invention, which will be described subsequently in greater detail, is to provide a new folding wagon assembly apparatus and method which has many of the advantages of the carts or wagons for transporting goods mentioned heretofore and many novel features that result in a new folding wagon assembly which is not anticipated, rendered obvious, suggested, or even implied by any of the prior art carts or wagons for transporting goods, either alone or in any combination thereof.

To attain this, the present invention generally comprises a wagon assembly comprising a folding bottom panel assembly and an upper rail assembly positioned in spaced relationship above the bottom panel assembly. Netting extends between the bottom panel assembly and the upper rail assembly to form a cargo compartment of the wagon. A pair of side members extend between the bottom panel assembly and the upper rail assembly. The upper rail assembly and the bottom panel assembly are each hingably coupled to the side members such that the upper rail assembly and the bottom panel assembly are foldable for compactly storing the wagon. A plurality of wheel assemblies are coupled to the bottom panel assembly for supporting the cargo compartment. A handle extends from the upper rail for facilitating movement of the cargo compartment.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new folding wagon assembly apparatus and method which has many of the advantages of the carts or wagons for transporting goods mentioned heretofore and many novel features that result in a new folding wagon assembly which is not anticipated, rendered obvious, suggested, or even implied by any of the prior art carts or wagons for transporting goods, either alone or in any combination thereof.

It is another object of the present invention to provide a new folding wagon assembly which may be easily and efficiently manufactured and marketed.

It is a further object of the present invention to provide a new folding wagon assembly which is of a durable and reliable construction.

An even further object of the present invention is to provide a new folding wagon assembly which is susceptible of a low cost of manufacture with regard to both materials and labor, and which accordingly is then susceptible of low prices of sale to the consuming public, thereby making such folding wagon assembly economically available to the buying public.

Still yet another object of the present invention is to provide a new folding wagon assembly which provides in the apparatuses and methods of the prior art some of the advantages thereof, while simultaneously overcoming some of the disadvantages normally associated therewith.

Still another object of the present invention is to provide a new folding wagon assembly for enhanced portability and compact storage.

Yet another object of the present invention is to provide a new folding wagon assembly which includes a wagon assembly comprising a folding bottom panel assembly and an upper rail assembly positioned in spaced relationship above the bottom panel assembly. Netting extends between the bottom panel assembly and the upper rail assembly to form a cargo compartment of the wagon. A pair of side members extend between the bottom panel assembly and the upper rail assembly. The upper rail assembly and the bottom panel assembly are each hingably coupled to the side members such that the upper rail assembly and the bottom panel assembly are foldable for compactly storing the wagon. A plurality of wheel assemblies are coupled to the bottom panel assembly for supporting the cargo compartment. A handle extends from the upper rail for facilitating movement of the cargo compartment.

Still yet another object of the present invention is to provide a new folding wagon assembly that can be quickly folded and placed in a trunk or back seat of a car.

Even still another object of the present invention is to provide a new folding wagon assembly that has improved stability thus increasing safety when used as an alternate to a children's stroller.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a schematic view of a new folding wagon assembly according to the present invention.

FIG. 2 is a schematic elevational view of the present invention.

FIG. 3 is a schematic view of the side members and upper rail assembly of the present invention.

FIG. 4 is a schematic view of the stabilizing bar assembly of the present invention.

FIG. 5 is a schematic detail view of the front wheel assembly of the present invention.

FIG. 6 is a schematic detail view of the rear wheel assembly of the present invention.

FIG. 7 is a schematic detail view of the handle of the present invention.

FIG. 8 is a schematic cross-sectional view of the upper rail assembly of the present invention taken along line 8-8 of FIG. 3.

FIG. 9 is a schematic elevational view of an embodiment the present invention.

FIG. 10 is a schematic elevational view of the embodiment of the present invention in a folded position.

FIG. 11 is a schematic elevational view of the side members and upper rail assembly of the embodiment of the present invention.

FIG. 12 is a schematic perspective view of the jointing of the stabilizing bar assembly of the present invention.

### DESCRIPTION OF THE PREFERRED EMBODIMENT

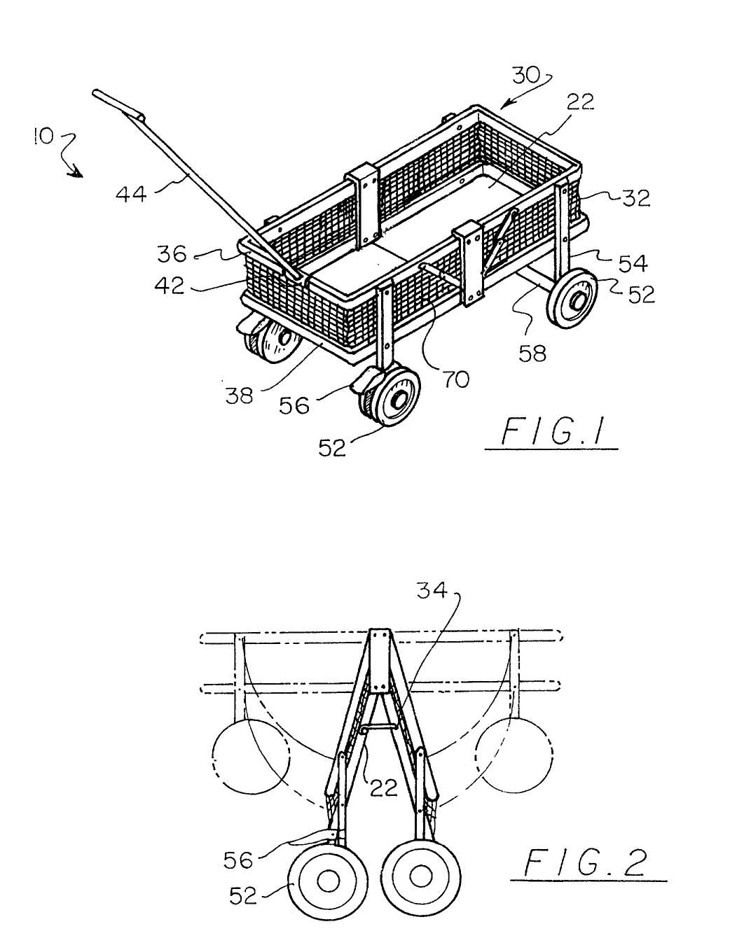

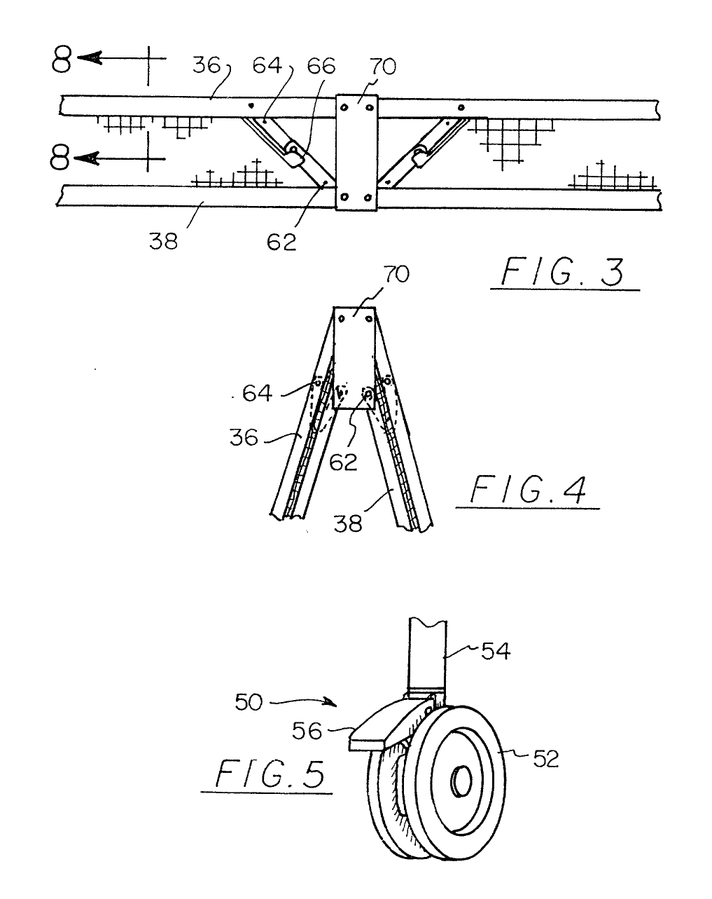

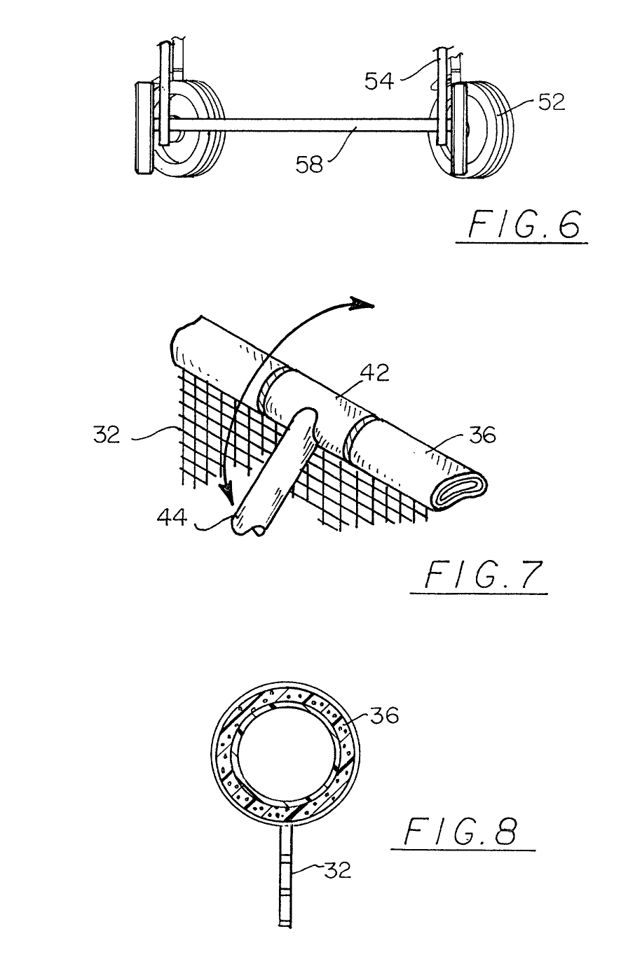

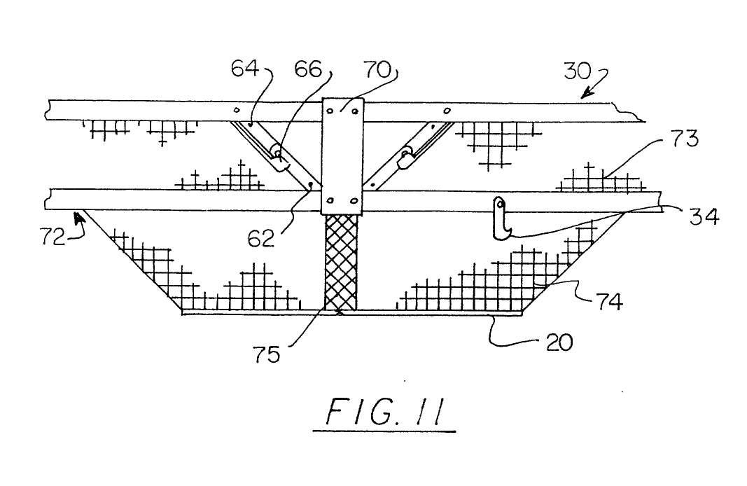

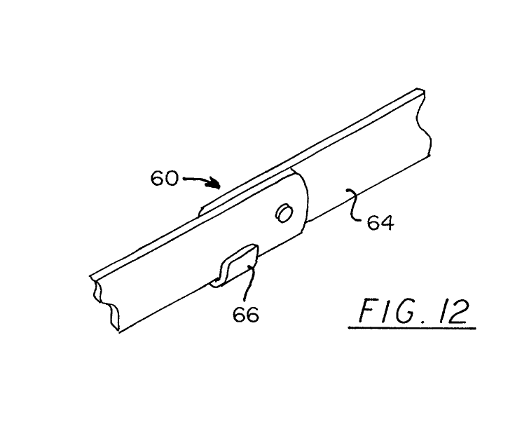

With reference now to the drawings, and in particular to FIGS. 1 through 12 thereof, a new folding wagon assembly embodying the principles and concepts of the present invention and generally designated by the reference numeral 10 will be described.

As best illustrated in FIGS. 1 through 12, the folding wagon assembly 10 generally comprises a folding bottom panel 20, an upper rail assembly 30, a pair of side members 70, a latch assembly 34, a plurality of wheel assemblies 50, a handle 40, an axle 58, and a pair of stabilizing bar assemblies 60.

The folding bottom assembly 20 includes a pair of bottom panel portions 22. Each of the bottom panel portions 22 has a stiff central member and a flexible material cover. The flexible material covers of each of the bottom panel portions 22 are joined to each other along a hinge line of the folding bottom panel assembly 20.

The upper rail assembly 30 is positioned in a spaced relationship above the bottom panel assembly 20. The netting 32 extends between the bottom panel assembly 20 and the upper rail assembly 30 to form a cargo compartment of the wagon 10. The pair of side members 70 extend between the bottom panel assembly 20 and the upper rail assembly 30. The upper rail assembly 30 and the bottom panel assembly 20 each are hingably coupled to the side members 70. Thus the upper rail assembly 30 and the bottom panel assembly 20 are foldable for compactly storing the wagon 10.

The latch assembly 34 is extendable between the bottom panel portions 22 when the bottom panel 20 is in the folded position. The latch assembly 34 holds the bottom panel 20 in the folded position.

The plurality of wheel assemblies 50 are coupled to the bottom panel assembly 20, and support the cargo compartment. Each of the wheel assemblies 50 has a connection member 54 which extends upwardly from the wheel 52. A medial portion of the connection member 54 is hingably coupled to the bottom panel assembly 20. An upper end portion of the connection member 54 is hingably coupled to the upper rail portion 30. Thus, each of the wheel assemblies 50 pivots relative to the bottom panel assembly 20 and the upper rail assembly 30 when the bottom panel assembly 20 and the upper rail assembly 30 are folded together. The axle 58 extends between a pair of rear wheel assemblies 50 for providing stability to the pair of rear wheels 52.

The forward pair of wheel assemblies 50 each includes a wheel locking member 56 for preventing the rotation of an associated wheel 52. Thus the wagon 10 is prevented from moving.

The pair of stabilizing bar assemblies 60 extend from opposite sides of one of the side members 70 for preventing the bottom panel assembly 20 and the upper rail assembly 30 from being folded in a first direction. Each of the stabilizing bars 60 has a first end 62 which is pivotally coupled to one of the side members 70. Each of the stabilizing bar assemblies 60 has a second end 64 which is pivotally coupled to the upper rail assembly 30.

Each of the stabilizing bar assemblies 60 is jointed in a medial portion of the stabilizing bar assembly 60. Thus each of the stabilizing bar assemblies 60 is foldable when the upper rail assembly 30 and the bottom panel assembly 20 are folded together.

Each of the stabilizing bar assemblies 60 has an associated anti-extension bracket 66. Thus the jointed medial portion is pivotable in one direction such that the bottom panel assembly 20 and the upper rail assembly 30 are prevented from being folded in the first direction. The anti-extension bracket is most preferably an integral extension of one of the jointed members forming each stabilizing bar assembly 60.

The upper rail assembly 30 includes a first rail portion 36 and a second rail portion 38. Each of the first 36 and second rail portions 38 has a generally circular cross-section. The upper rail assembly 30 includes a core portion and a foam coating which substantially covers the core portion.

The handle 40 extends from the upper rail assembly 30 for facilitating movement of the cargo compartment. The handle 40 has a connection portion 42 and an extension portion 44. The extension portion 44 extends outwardly from the connection portion 42. The connection portion 42 is coupled to the first rail portion 36. The connection portion 42 is generally cylindrical and has a diameter about equal to the diameter of the circular cross-section of the first rail portion 36. The connection portion 42 is positioned concentrically with a cross member of the first rail portion 36 such that the extension portion 44 of the handle pivots about a longitudinal axis of the cross member of the first rail portion 36.

The forward pair of wheel assemblies 50 are pivoted such that the associated wheels 52 are free to rotate around a longitudinal axis of an associated connection member 54 of the forward pair of wheel assemblies 50 for facilitating steering of the wagon 10.

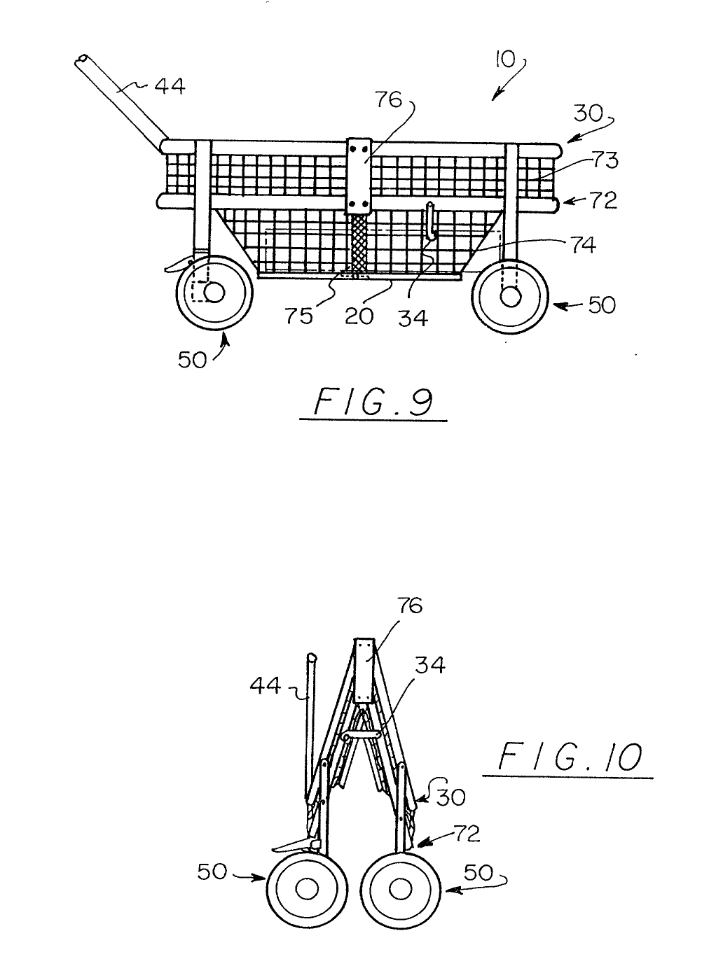

In an embodiment, as shown in FIGS. 9 through 11, a medial rail assembly 72 is positioned between the upper rail assembly 30 and the bottom panel assembly 20. A first netting member 73 extends between the bottom panel assembly 20 and the medial rail assembly 72. A second netting member 74 extends between the medial rail assembly 72 and the upper rail assembly 30 to form a cargo compartment of the wagon. A pair of support webbing members 75 extend between the bottom panel assembly 20 and the medial rail assembly 72 for providing support to the folding bottom panel assembly 20.

A pair of side members 76 extend between the medial rail assembly 72 and the upper rail assembly 30. The upper rail assembly 30 and the medial rail assembly 72 are each hingably coupled to the side members 76 such that the upper rail assembly 30 and the medial rail assembly 72 are foldable for compactly storing the wagon. The upper rail assembly 30 and the medial rail assembly 72 each include a core portion and a foam coating substantially covering the core portion. Each of the stabilizing bar assemblies 60 comprises an associated anti-extension bracket 66 such that the jointed medial portion is pivotable in one direction such that the medial rail assembly 72 and the upper rail assembly 30 are prevented from being folded in the first direction.

A plurality of wheel assemblies 50 are coupled to the medial rail assembly 72 for supporting the cargo compartment. Each of the wheel assemblies 50 comprises a connection member 54 extending upwardly from a wheel 52. A medial portion of the connection member 54 is hingably coupled to the medial rail assembly 72. An upper end portion of the connection member 54 is hingably coupled to the upper rail assembly 30 such that each of the wheel assemblies 50 pivots relative to the medial rail assembly 72 and the upper rail assembly 30 when the medial rail assembly 72 and the upper rail assembly 30 are folded together.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A wagon assembly comprising:
a folding bottom panel assembly;
an upper rail assembly positioned in spaced relationship above the bottom panel assembly;
netting extending between said bottom panel assembly and said upper rail assembly to form a cargo compartment of said wagon;
a pair of side members extending between said bottom panel assembly and said upper rail assembly;
said upper rail assembly and said bottom panel assembly each being hingably coupled to said side members whereby said upper rail assembly and said bottom panel assembly are foldable for compactly storing said wagon;
a plurality of wheel assemblies coupled to said bottom panel assembly for supporting said cargo compartment; and
a handle extending from said upper rail for facilitating movement of said cargo compartment.

2. The wagon assembly of claim 1, further comprising:
each of said wheel assemblies having a connection member extending upwardly from a wheel, a medial portion of said connection member being hingably coupled to said bottom panel assembly and an upper end portion of said connection member being hingably coupled to said upper rail portion whereby each of said wheel assemblies pivots relative to said bottom panel assembly and said upper rail assembly when said bottom panel assembly and said upper rail assembly are folded together.

3. The wagon assembly of claim 1, further comprising:
a forward pair of said wheel assemblies each including a wheel locking member for preventing rotation of an associated wheel whereby said wagon is prevented from moving.

4. The wagon assembly of claim 1, further comprising:
an axle extending between a pair of rear wheels said wheel assemblies for providing stability to said pair of rear wheels.

5. The wagon assembly of claim 1, further comprising:
a pair of stabilizing bar assemblies extending from opposite sides of one of said side members for preventing said bottom panel assembly and said upper rail assembly from being folded in a first direction, each of said stabilizing bar assemblies having a first end pivotally coupled to said one of said side members, each of said stabilizing bar assemblies having a second end pivotally coupled to said upper rail assembly; and
each of said stabilizing bar assemblies being jointed in a medial portion of said stabilizing bar assembly whereby each of said stabilizing bar assemblies is foldable when said upper rail assembly and bottom panel assembly are folded together.

6. The wagon assembly of claim 5, further comprising:
each of said stabilizing bar assemblies having an associated anti-extension bracket whereby said jointed medial portion is pivotable in one direction such that said bottom panel assembly and said upper rail assembly are prevented from being folded in said first direction.

7. The wagon assembly of claim 1, further comprising:
said upper rail assembly including a first rail portion and a second rail portion, each of said first and second rail portions having a generally circular cross-section;
said handle having a connection portion and an extension portion extending outwardly from said connection portion, said connection portion being coupled to said first rail portion, said connection portion being generally cylindrical and having a diameter about equal to a diameter of said circular cross-section of said first rail portion, said connection portion being positioned concentrically with a cross member of said first rail portion such that said extension portion of said handle pivots about a longitudinal axis of said cross member of said first rail portion.

8. The wagon assembly of claim 1, further comprising:
said upper rail assembly including a core portion and a foam coating substantially covering said core portion.

9. The wagon assembly of claim 3, further comprising:
said forward pair of said wheel assemblies being pivoted such that said associated wheels are free to rotate around a longitudinal axis of an associated connection member of said forward pair of wheel assemblies for facilitating steering of said wagon.

10. A wagon assembly comprising:
a folding bottom panel assembly;
an upper rail assembly positioned in spaced relationship above the bottom panel assembly;
a medial rail assembly positioned between said upper rail assembly and said bottom panel assembly;
a first netting member extending between said bottom panel assembly and said medial rail assembly and a second netting member extending between said medial rail assembly and said upper rail assembly to form a cargo compartment of said wagon;
a pair of support webbing members extending between said bottom panel assembly and said medial rail assembly for providing support to said folding bottom panel assembly;
a pair of side members extending between said medial rail assembly and said upper rail assembly;
said upper rail assembly and said medial rail assembly each being hingably coupled to said side members whereby said upper rail assembly and said medial rail assembly are foldable for compactly storing said wagon;
a plurality of wheel assemblies coupled to said medial rail assembly for supporting said cargo compartment; and
a handle extending from said upper rail for facilitating movement of said cargo compartment.

11. The wagon assembly of claim 10, further comprising:
each of said wheel assemblies having a connection member extending upwardly from a wheel, a medial portion of said connection member being hingably coupled to said medial rail assembly and an upper end portion of said connection member being hingably coupled to said upper rail portion whereby each of said wheel assemblies pivots relative to said medial rail assembly and said upper rail assembly when said medial rail assembly and said upper rail assembly are folded together.

12. The wagon assembly of claim 10, further comprising:
a forward pair of said wheel assemblies each including a wheel locking member for preventing rotation of an associated wheel whereby said wagon is prevented from moving.

13. The wagon assembly of claim 10, further comprising:
an axle extending between a pair of rear wheels said wheel assemblies for providing stability to said pair of rear wheels.

14. The wagon assembly of claim 10, further comprising:
a pair of stabilizing bar assemblies extending from opposite sides of one of said side members for preventing said bottom panel assembly and said upper rail assembly from being folded in a first direction, each of said stabilizing bar assemblies having a first end pivotally coupled to said one of said side members, each of said stabilizing bar assemblies having a second end pivotally coupled to said upper rail assembly; and
each of said stabilizing bar assemblies being jointed in a medial portion of said stabilizing bar assembly whereby each of said stabilizing bar assemblies is foldable when said upper rail assembly and bottom panel assembly are folded together.

15. The wagon assembly of claim 14, further comprising:
each of said stabilizing bar assemblies having an associated anti-extension bracket whereby said jointed medial portion is pivotable in one direction such that said medial rail assembly and said upper rail assembly are prevented from being folded in said first direction.

16. The wagon assembly of claim 10, further comprising:
said upper rail assembly including a first rail portion and a second rail portion, each of said first and second rail portions having a generally circular cross-section;
said handle having a connection portion and an extension portion extending outwardly from said connection portion, said connection portion being coupled to said first rail portion, said connection portion being generally cylindrical and having a diameter about equal to a diameter of said circular cross-section of said first rail portion, said connection portion being positioned concentrically with a cross member of said first rail portion such that said extension portion of said handle pivots about a longitudinal axis of said cross member of said first rail portion.

17. The wagon assembly of claim 10, further comprising:
said upper rail assembly and said medial rail assembly each including a core portion and a foam coating substantially covering said core portion.

18. The wagon assembly of claim 12, further comprising:
said forward pair of said wheel assemblies being pivoted such that said associated wheels are free to rotate around a longitudinal axis of an associated connection member of said forward pair of wheel assemblies for facilitating steering of said wagon.

19. A wagon assembly comprising:
a folding bottom panel assembly, said bottom panel assembly including a pair of bottom panel portions, each bottom panel portion having a stiff central member and a flexible material cover, said flexible material covers of each of said bottom panel portions being joined to each other along a hinge line of said folding bottom panel assembly;
an upper rail assembly positioned in spaced relationship above the bottom panel assembly;
netting extending between said bottom panel assembly and said upper rail assembly to form a cargo compartment of said wagon;
a pair of side members extending between said bottom panel assembly and said upper rail assembly;
said upper rail assembly and said bottom panel assembly each being hingably coupled to said side members whereby said upper rail assembly and said bottom panel assembly are foldable for compactly storing said wagon;
a latch assembly extendable between said bottom panel portions when said bottom panel is folded into a folded position for holding said bottom panel in said folded position;
a plurality of wheel assemblies coupled to said bottom panel assembly for supporting said cargo compartment;
a handle extending from said upper rail for facilitating movement of said cargo compartment;
each of said wheel assemblies having a connection member extending upwardly from a wheel, a medial portion of said connection member being hingably coupled to said bottom panel assembly and an upper end portion of said connection member being hingably coupled to said upper rail portion whereby each of said wheel assemblies pivots relative to said bottom panel assembly and said upper rail assembly when said bottom panel assembly and said upper rail assembly are folded together;
a forward pair of said wheel assemblies each including a wheel locking member for preventing rotation of an associated wheel whereby said wagon is prevented from moving;
an axle extending between a pair of rear wheels said wheel assemblies for providing stability to said pair of rear wheels;
a pair of stabilizing bar assemblies extending from opposite sides of one of said side members for preventing said bottom panel assembly and said upper rail assembly from being folded in a first direction, each of said stabilizing bar assemblies having a first end pivotally coupled to said one of said side members, each of said stabilizing bar assemblies having a second end pivotally coupled to said upper rail assembly;
each of said stabilizing bar assemblies being jointed in a medial portion of said stabilizing bar assembly whereby each of said stabilizing bar assemblies is foldable when said upper rail assembly and bottom panel assembly are folded together;
each of said stabilizing bar assemblies having an integral anti-extension bracket whereby said jointed medial portion is pivotable in one direction such that said bottom panel assembly and said upper rail assembly are prevented from being folded in said first direction;
said upper rail assembly including a first rail portion and a second rail portion, each of said first and second rail portions having a generally circular cross-section;
said handle having a connection portion and an extension portion extending outwardly from said connection portion, said connection portion being coupled to said first rail portion, said connection portion being generally cylindrical and having a diameter about equal to a diameter of said circular cross-section of said first rail portion, said connection portion being positioned concentrically with a cross member of said first rail portion such that said extension portion of said handle pivots about a longitudinal axis of said cross member of said first rail portion;
said upper rail assembly including a core portion and a foam coating substantially covering said core portion; and
said forward pair of said wheel assemblies being pivoted such that said associated wheels are free to rotate around a longitudinal axis of an associated connection member of said forward pair of wheel assemblies for facilitating steering of said wagon.
